(19) United States
(12) Patent Application Publication
(10) Pub. No.: US 2012/0169171 A1
(43) Pub. Date: Jul. 5, 2012

(54) ELECTRICAL MACHINE, ROTOR APPARATUS, AND METHOD

(76) Inventors: Patrick L. JANSEN, Schenectady, NY (US); Daniel M. Saban, Clifton Park, NY (US)

(21) Appl. No.: 12/981,800

(22) Filed: Dec. 30, 2010

(51) Int. Cl. H02K 1/27

(52) U.S. Cl. 310/156.49

(57) ABSTRACT

An apparatus includes a rotor and a magnet disposed on the rotor. The apparatus also includes a pole cap proximate to the at least one magnet disposed on the rotor. The pole cap is magnetically coupled to the magnet and has a laterally asymmetric profile.

### FIELD OF THE INVENTION

Embodiments of the invention relate generally to permanent magnet electrical machines. Other embodiments relate generally to permanent magnet generators for wind turbines.

### BACKGROUND OF THE INVENTION

Permanent magnet (PM) electrical machines are used both as motors and as generators and may be constructed for alternating-current (AC) or direct-current (DC) operation. Such machines typically employ magnets that are attached to a rotor. The magnets may be attached in a variety of ways including through the use of a “pole cap” rotor topology in which permanent magnets are sandwiched between a rotor rim and a pole cap. Pole caps are typically formed from a ferromagnetic material such as laminated electrical steel sheets, but may also be manufactured from low or medium carbon steel sheets and soft magnetic composites. For simplicity of manufacture, and for dynamic balancing of the PM machine, conventional pole caps are formed with identical structural profiles and are attached to a rotor so as to be symmetrical about the circumferential direction of the rotor.

Such machines, however, are often susceptible to a form of electromagnetic feedback called “torque ripple.” In particular, torque ripple occurs when currents induced in a stator form magnetic fields that induce opposing currents, magnetic fields, and torque in a rotor. Torque ripple varies depending at least on relative rotational position of the rotor and the stator and on the number of rotor pole pieces and stator windings. As will be appreciated, torque ripple is undesirable, as it causes noise and vibration, reduces the life of gears and bearings, and performs no useful work. Accordingly, various means have been proposed to reduce torque ripple, as discussed below.

One way of potentially reducing torque ripple is to skew the stator windings in the machine. Skewing stator windings adds complexity and cost to the windings, however, and reduces the overall performance of the electrical machine. Stator skewing also increases the amount of copper required, increases the stator copper losses, and reduces the torque per amp performance of the machine, in addition to significantly complicating the design and formation of the stator coils and core, and the insertion of the stator windings into the stator core.

Skewing the rotor may also reduce torque ripple. Rotor skewing is typically done by twisting the entire rotor (magnet and rotor core) at discrete axial locations. Skewing a rotor is challenging to accomplish correctly, however, mainly due to the rigid/solid/nonconforming structure of the permanent magnet material. In particular, permanent magnets are not amenable to being “bent” at a skew angle, unlike copper coils of the stator windings.

Other approaches to rotor skewing that do not involve twisting the rotor are also challenging to accomplish. For example, rotor skewing may be attained by mounting selected permanent magnets at aperiodic locations about a rotor circumference, or by mounting unmagnetized permanent magnets at offset locations on a rotor, and then magnetizing the entire rotor using a special wound fixture. These approaches require considerable care in meeting tolerances for relative positioning of components, and, accordingly, both are time consuming and expensive.

In view of the above, a need remains for a simple and inexpensive yet effective method to reduce torque ripple in PM electrical machines.

### BRIEF DESCRIPTION OF THE INVENTION

In one embodiment of the invention, an apparatus includes a rotor with at least a first magnet disposed on the rotor, and producing a magnetic field. A first pole cap is proximate to the first magnet, and a second pole cap is proximate to the first magnet or to a second magnet also disposed on the rotor. At least one of the first pole cap and the second pole cap magnetically couples to at least one of the first magnet and/or the second magnet, and displaces at least a portion of the magnetic field produced by the first and/or second magnet.

In another embodiment of the invention, an electrical machine includes a rotor rotatably mounted within the electrical machine, and a plurality of magnets disposed on the rotor, each magnet producing a magnetic field. The electrical machine also includes a first plurality of pole caps proximate to the plurality of magnets disposed on the rotor, and magnetically coupling with a first group of the plurality of magnets to produce a first plurality of pole cap magnetic fields displaced from the magnetic fields of the magnets. The electrical machine further includes a second plurality of pole caps proximate to the plurality of magnets disposed on the rotor, and magnetically coupling with a second group of the plurality of magnets to produce a second plurality of pole cap magnetic fields displaced from the magnetic fields of the magnets. The displacement of the first and second pluralities of pole cap magnetic fields from the first and second plurality of magnet magnetic fields reduces torque ripple induced by rotation of the rotor within the electrical machine.

In yet another embodiment of the invention, circumferential locations of first and second pluralities of pole pieces producing pole piece magnetic fields are established. The first plurality of pole piece magnetic fields then are displaced by a first offset. Displacing the first plurality of pole piece magnetic fields may include disposing proximate to selected pole pieces a first plurality of pole caps having a first asymmetric magnetic profile.

In a further embodiment of the invention, an apparatus includes a rotor having a magnet disposed on the rotor, and producing a magnetic field. The apparatus also includes a pole cap proximate to the magnet disposed on the rotor. The pole cap is magnetically coupled to the magnet and has a laterally asymmetric profile.

### BRIEF DESCRIPTION OF THE DRAWINGS

The present invention will be better understood from reading the following description of non-limiting embodiments, with reference to the attached drawings; wherein below:

FIG. 1 is a side elevation view of a wind turbine installation.

FIG. 2 is an end view of a first ferromagnetic pole cap with an laterally asymmetric profile according to an embodiment of the present invention.

FIG. 3 is an end view of a second ferromagnetic pole cap with an laterally asymmetric profile according to an embodiment of the present invention.

FIG. 4 is a perspective view of a partially-assembled pole piece assembly including a pattern of asymmetric pole caps according to an embodiment of the present invention.

FIG. 5 is a perspective partial view of the fully-assembled pole piece assembly shown in FIG. 4, according to an embodiment of the present invention.

FIG. 6 is an axial partially cutaway view of the pole piece assembly shown in FIG. 5, mounted to a rotor body for installation in an electrical machine.

FIGS. 7 and 8 are plots of sectional and composite torque ripple waves produced according to an embodiment of the present invention.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

Embodiments of the present invention reduce torque ripple in electrical machines. Such electrical machines may include, but are not limited to, PM motors, brakes, and synchros. In particular, such electrical machines include PM generators that may be employed in wind turbines.

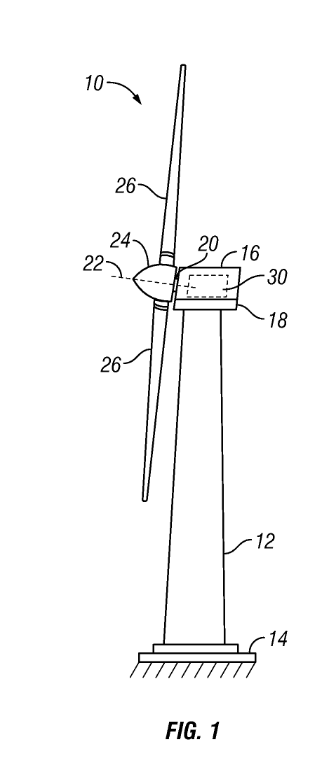

FIG. 1 depicts a wind energy turbine 10 that includes a tower 12 mounted on a foundation 14, with a nacelle 16 mounted atop the tower 12 via a positioning assembly 18. The nacelle 16 houses a shaft 20 defining an axis 22. The shaft 20 supports a hub 24, to which turbine blades 26 are mounted. The nacelle 16 also houses an integrated drivetrain and power conversion module 30, driven by the shaft 20. The module 30 includes a PM generator.

The PM generator, in turn, includes a rotor with a plurality of pole assemblies. Each pole assembly has several permanent magnets or pole pieces disposed on an outer surface of a rotor body to provide a pole field. The permanent magnets are covered by pole caps to protect them from mechanical damage.

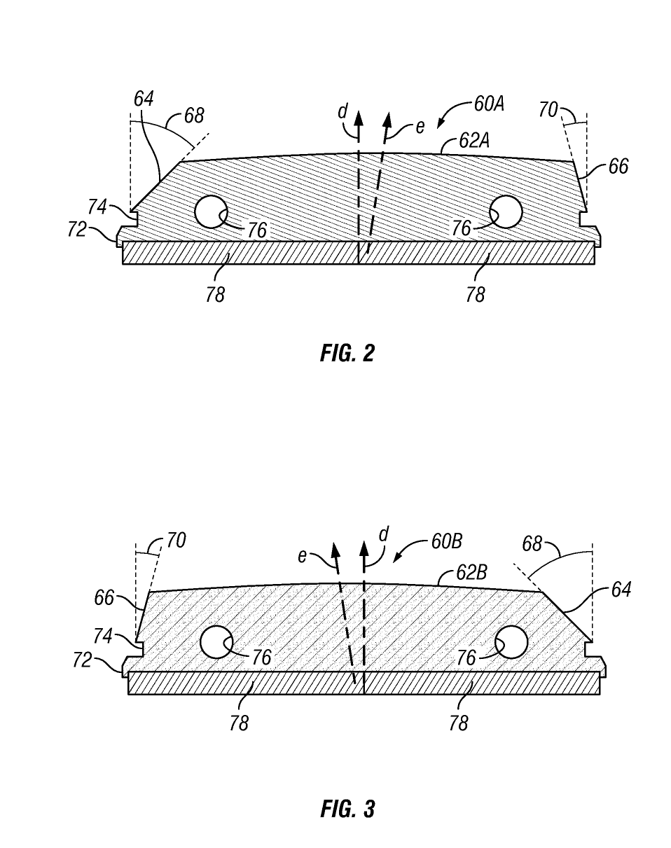

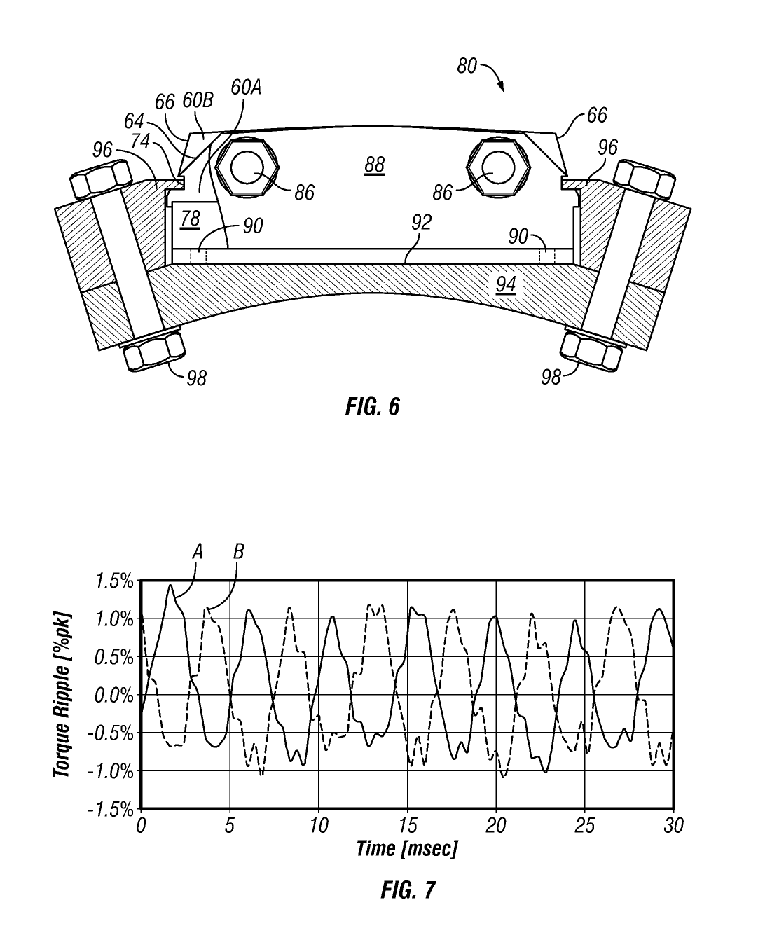

FIGS. 2 and 3 illustrate an embodiment of an inventive rotor apparatus that reduces the aforementioned undesirable torque ripple. As shown, the apparatus includes asymmetrical pole caps 60A and 60B. Each pole cap 60A or 60B has a laterally asymmetric structural profile 62A or 62B, respectively. As seen from an axial end view in FIGS. 2 and 3, each profile 62A or 62B has two laterally opposed edges 64, 66 disposed at differing axially uniform bevel angles 68, 70. Each of the pole caps 60A, 60B also includes feet 72 (for engaging with radial edges of permanent magnets to be covered by the pole caps, as further discussed below) and grooves 74 (which may be used for mounting the pole caps to a rotor as further discussed with reference to FIG. 6, below). Additionally, mounting holes 76 are indented axially through the pole caps 60A and 60B. The mounting holes 76 are evenly spaced between the ends 64, 66 to provide for mutual alignment of the pole caps. Alternatively, the grooves 74, or similar peripheral indentations, may be used for alignment of adjacent pole caps in addition to or in place of the holes 76.

By placing one of the ferromagnetic pole caps 60A, 60B over one or more permanent magnets 78, variations in magnetic reluctance across the pole cap profile 62 can produce a pole cap magnetic field with an effective magnetic-axis e (the “e-axis”) that is shifted across the pole cap profile 62 relative to the magnetic axis d (the “d-axis”) of the magnetic field produced by the permanent magnet(s) 78 beneath the pole cap. For example, FIG. 2 shows a pole cap 60A and permanent magnets 78 assembled so that the pole cap magnetic field e-axis is laterally shifted to the right relative to the magnet d-axis. By contrast, FIG. 3 shows a pole cap 60B and permanent magnets 78 assembled so that the pole cap e-axis is laterally shifted to the left relative to the magnet d-axis.

FIGS. 2 and 3 depict the pole caps 60A and 60B having the exact same lateral profile shapes that are merely flipped end-to-end with respect to each other in a mirror-symmetric fashion. Thus, adjacent pole caps 60A, 60B may be easily assembled to displace the magnetic fields (d-axes) of underlying first and second groups of permanent magnets 78 to provide a staggered or stair-step pattern of effective pole cap magnetic fields (e-axes). Thus, a combination of circumferentially or laterally asymmetric pole caps 60A, 60B, stacked along an axial array of permanent magnets 78 in periodically reversed (flipped) orientations, will step-skew the overall rotor magnetic field to dramatically reduce torque ripple.

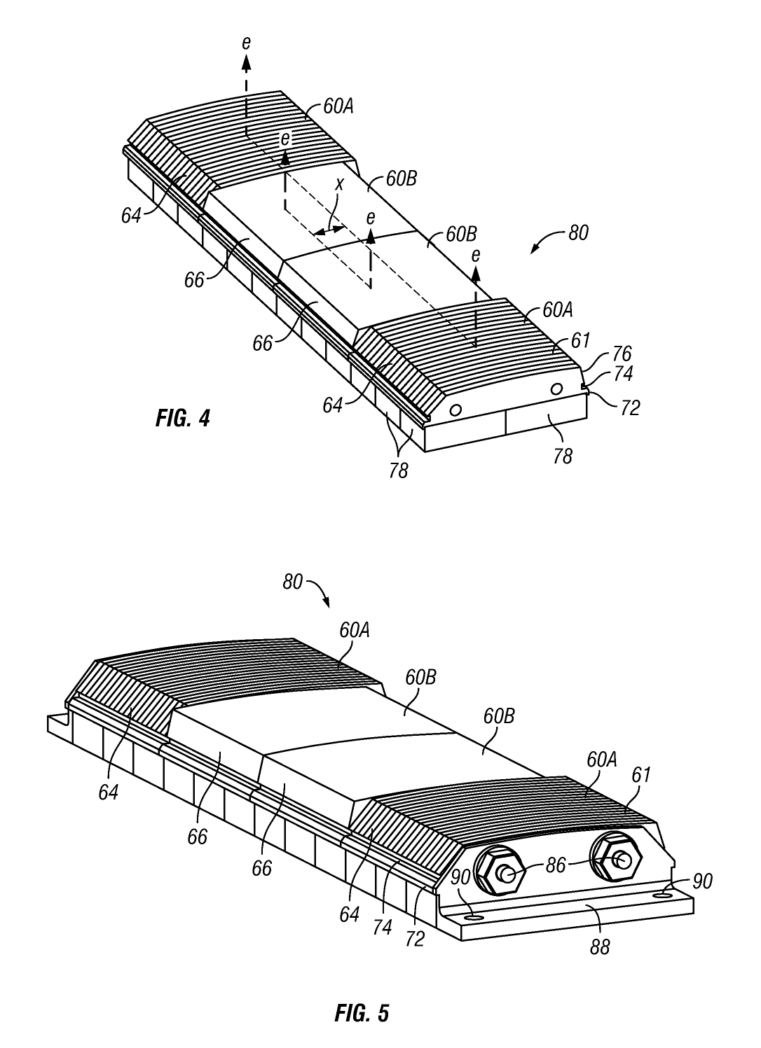

Turning now to FIG. 4, a partial pole assembly 80 according to an embodiment of the present invention is depicted. The pole assembly 80 includes asymmetrical pole caps 60A, 608 assembled over underlying first and second groups of permanent magnets 78. Adjacent pole caps 60A and 60B are flipped end-for-end so that the orientation of the asymmetrical pole caps follows a 60A-60B-60B-60A orientation pattern along the axial length of the pole assembly. The 60A-60B-60B-60A pattern of pole caps 60 are overlaid on the permanent magnets 78 to displace portions of the uniform pole field corresponding to each group of underlying magnets and to thereby provide a stair-step staggered pattern of effective magnetic fields along the assembly, where e-axes (effective magnetic fields) of the 60A pole caps are offset by a lateral or circumferential distance x from e-axes of the 60B pole caps. Alternative patterns such as 60A-60B, 60A-60B-60A-60B, and 60B-60A-60A-60B also are possible. Also, individual pole caps 60 may be formed with axially-varying magnetic profiles so that more complex displacements patterns, such as sawtooths, sine waves, or continuous helices, may be imposed on the uniform pole field of the permanent magnets 78. The first and second groups of the permanent magnets 78 may include all the same magnets (in other words, each magnet may extend axially under at least one of the pole caps GOA and under at least one of the pole caps GOB). Alternatively, some magnets in the first group and some magnets in the second group may extend under at least one pole cap 60A and under at least one pole cap 60B, while other magnets in each group may only be under one of the pole caps 60A or one of the pole caps 60B. Alternatively, each of the magnets 78 in the first group of magnets may be under one of the pole caps 60A, while each of the magnets in the second group of magnets may be under one of the pole caps GOB.

As shown in FIG. 4, each pole cap can be formed from an axial stack of electrical steel sheets 61, or other ferromagnetic laminates, shaped and arranged to provide the asymmetric axial profile 62. Also, in some embodiments of the present invention, some or all of the pole caps 60 may be molded from a soft magnetic composite (SMC) to have magnetically asymmetric axial profiles. Magnetic profiles may be adjusted, for example, by physically shaping the composite pole caps or by controlling placement of ferromagnetic particles within the composite pole caps, so that magnetic reluctance of a pole cap varies according to location across its magnetic profile. Other methods will be apparent in view of the present disclosure. Also, though pole caps with only axially uniform bevel edges are illustrated, pole caps may also be formed with rounded, chamfered, or axially-angled sides, any combination of bevel and chamfer, or any other rounding or “shaping” of the pole cap as desired.

FIG. 5 illustrates a complete pole assembly 80 according to an embodiment of the present invention, prior to mounting on a rotor body. The assembly 80 includes axial through bolts (rods) 86 for assembly through the pole cap holes 76, and through endplate brackets 88, to compress and align the stacked laminations of the pole caps 60. Thus by mounting the brackets 88 to a rotor body by way of bolts through holes 90 formed in the brackets, it is possible to locate the effective magnetic fields of each pole 80 with reference to the other pole assemblies mounted on the rotor body.

Alternatively, the pole caps 60A, 60B and the underlying permanent magnets 78 can be mounted onto an outer surface 92 of a rotor body 94 via a combination of clamping bars 96 and mounting bolts 98, as shown in FIG. 6. FIG. 6 illustrates an axial end view of the rotor pole assembly 80 of FIG. 5, wherein the 60A and 60B combination of reversing the orientation of the asymmetrical pole caps creates a net effective pole d-axis that is aligned with the d-axis of the magnets, while the 60A and 60B pole cap e-axes are shifted relative to each other. The rods 86 hold the pole caps 60A, 60B in mutual alignment, while the clamping bars 96 engage into the grooves 74 of the pole caps GOA, GOB, thereby holding the mutually aligned pole caps in alignment with the rotor body 94 and with the magnets 78. Note that the magnets 78 and mounting hardware 86, 88, 96, 98 may be fastened at uniformly spaced positions around the rotor circumference, thereby maintaining simplicity of manufacture, ease of assembly, and overall low costs comparable to conventional permanent rotors. In FIG. 6, the clamping bars 96 preferably are of a non-magnetic non-conductive material such as G10 or G11 fiber-reinforced polymer, but may also be of austenitic stainless steel. The clamping bars 96 extend axially along the rotor, while the mounting bolts 98 are fastened through the rotor body 94. The rotor body 94 typically is fabricated of a mild or medium carbon steel and provides both structural integrity as well as a low reluctance path for magnetic flux from the magnets.

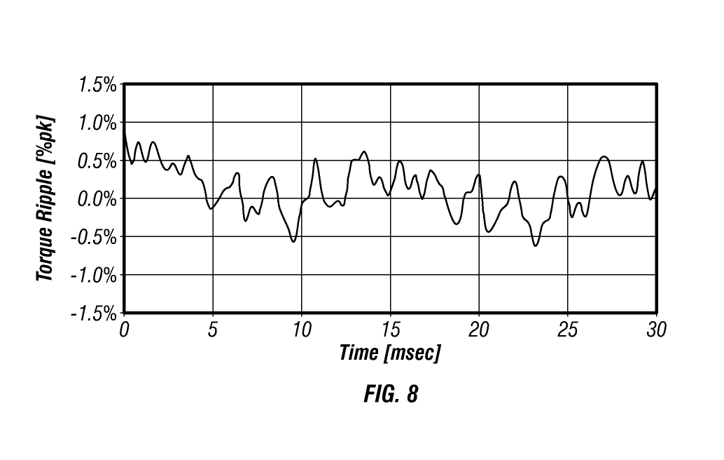

As shown in FIGS. 7 and 8, PM electrical machines with rotors according to embodiments of the invention can significantly reduce torque ripple compared to conventional PM electrical machines and rotors. FIG. 7 illustrates instantaneous torque ripple waveforms produced by each of the A and B sections of the pole assembly 80. It is seen that by flipping the pole caps 60 along the assembly 80, the respective e-axes and torque ripple waveforms of the individual A and B axial sections are also flipped relative to each other. That is, sections of the asymmetrical pole caps are circumferentially reversed (i.e., flipped) relative to each other along the axial length of the rotor, such that instantaneous torque ripple is shifted in time for each of the asymmetrical sections, thereby nulling or cancelling significant components of the torque ripple. When the shifts of the A and B sections are combined over the entire rotor length, however, there is no net effective shift of the d-axis, thereby the fundamental torque properties of the electrical machine are preserved as seen in the plot of overall torque ripple induced in the rotor 94 in FIG. 8.

FIG. 8 illustrates a composite waveform produced by the entire pole assembly 80, wherein the main component of the torque ripple waveforms (e.g., a sixth harmonic of rotational speed) is effectively canceled out by the staggered A and B waveforms, resulting in a torque ripple that is significantly reduced.

Another aspect of the invention relates to establishing circumferential locations within an electrical machine of first and second pluralities of pole pieces producing pole piece magnetic fields, and displacing the first plurality of pole piece magnetic fields by a first offset. The first plurality of pole piece magnetic fields may be displaced by disposing a first plurality of pole caps adjacent to the first plurality of pole pieces. Additionally, the second plurality of pole piece magnetic fields may be displaced by a second offset different from the first offset. The first and second pluralities of displaced magnetic fields may form an axial stair step pattern around the rotor. The first and second pluralities of displaced magnetic fields may be axially continuous and skewed from the rotor axis. The first and second pluralities of displaced magnetic fields may be symmetrically axially skewed.

In use, an embodiment of the invention may include a rotor with at least a first magnet disposed on the rotor to produce a magnetic field, a first pole cap operatively connecting at least the first magnet to the rotor, and a second pole cap operatively connecting the first magnet, and/or at least a second magnet, to the rotor. At least one of the first pole cap and the second pole cap magnetically couples to the first magnet and/or the second magnet to displace at least a portion of the magnetic field produced by the magnet or magnets. The first and second pole caps may have respective first and second magnetic profiles that are asymmetric, and may be magnetically coupled to selected magnets to displace the magnetic fields of the selected magnets. The selected magnets may be the same or different magnets. The first and second pole caps each may circumferentially displace the magnetic field of at least one selected magnet, such that the displaced magnetic fields form a substantially continuous axially skewed pattern or an axial stair step pattern. The respective first and second magnetic profiles may be mirror-symmetric to each other. The first and second pole caps may be members of respective first and second pluralities of pole caps that are mounted in a repeating pattern. Each of the second plurality of pole caps may have an inverse axial profile to an adjacent one of the first plurality of pole caps. A rim of the rotor may include a flattened region, and the magnet may have a flattened surface complementary to the flattened region. The first pole cap may be mounted to the rotor by a mounting bar that engages an axially extending indentation of the first pole cap and that also engages an axially extending indentation of the second pole cap to align the first and second pole caps. The mounting bar may engage with a mounting structure formed on a bracket secured to the rotor adjacent to the flattened region formed at the rim of the rotor. The bracket and the mounting bar may mutually align the first and second pole caps with each other and with the magnet for locating the displaced magnetic field of the magnet relative to the rotor.

In other embodiments, the inventive apparatus may also include a rotor rotatably mounted within an electrical machine, a first plurality of pole caps operatively connecting a first plurality of magnets to the rotor, each of the magnets in the first plurality having a magnetic field, and magnetically coupling with the first plurality of magnets to produce a first plurality of pole cap magnetic fields circumferentially displaced from the magnetic fields of the magnets, and a second plurality of pole caps operatively connecting a second plurality of magnets to the rotor, each of the magnets in the second plurality haying a magnetic field, and magnetically coupling with the second plurality of magnets to produce a second plurality of pole cap magnetic fields displaced from the magnetic fields of the magnets. The mutual displacement of the first and second pluralities of pole cap magnetic fields from the first and second plurality of magnet magnetic fields may reduce the magnitude of torque ripple induced by rotation of the rotor within the electrical machine. The first plurality of pole cap magnetic fields and the second plurality of pole cap magnetic fields may form an axial stair step pattern. Alternatively, the first plurality of pole cap magnetic fields and the second plurality of pole cap magnetic fields form substantially continuous helices. The first plurality of pole cap magnetic fields and the second plurality of pole cap magnetic fields may be mirror-symmetrically axially skewed.

One of ordinary skill in the art will understand that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second.” “third,” “upper,” “lower.” “bottom.” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including.” or “having” an element or a plurality of elements having a particular property may include additional such elements not having that property.

Since certain changes may be made in the above-described embodiments, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An apparatus comprising:
a rotor;
at least a first magnet disposed on the rotor, and producing a magnetic field;
a first pole cap proximate to the first magnet;
a second pole cap proximate to the first magnet or to a second magnet also disposed on the rotor; and
at least one of the first pole cap and the second pole cap magnetically coupling to at least one of the first magnet and/or the second magnet, to displace at least a portion of the magnetic field produced by the first magnet and/or the second magnet.

2. The apparatus as claimed in claim 1, wherein the first magnet is included in a first plurality of magnets and the second magnet is included in a second plurality of magnets, wherein the first and second pole caps have respective first and second magnetic profiles that are asymmetric, and are magnetically coupled to at least the first magnet and to at least the second magnet to displace the magnetic fields of at least the first magnet and the second magnet.

3. The apparatus as claimed in claim 2, wherein the first and second pole caps each circumferentially displace the magnetic fields of the first and second pluralities of magnets so that the displaced magnetic fields form a substantially continuous axially skewed pattern or an axial stair step pattern.

4. The apparatus as claimed in claim 1, wherein the first magnet is included in a first plurality of magnets and the second magnet is included in a second plurality of magnets and wherein the first and second pole caps have respective first and second magnetic profiles that are mirror-symmetric to each other, and are magnetically coupled to at least the first magnet and to at least the second magnet to circumferentially displace the magnetic fields of the first and second pluralities of magnets.

5. The apparatus as claimed in claim 4, wherein the first and second pole caps displace the magnetic fields of the magnets in an axially continuous skewed pattern or an axial stair step pattern.

6. The apparatus as claimed in claim 1, further comprising first and second pluralities of pole caps that are magnetically asymmetric to one another, wherein the first pole cap is one of the first plurality of pole caps and the second pole cap is one of the second plurality of pole caps, and the first and second pluralities of pole caps are mounted in a repeating pattern.

7. The apparatus as claimed in claim 6, wherein each of the second plurality of pole caps has an inverse lateral profile to an adjacent one of the first plurality of pole caps.

8. The apparatus as claimed in claim 1, wherein a rim of the rotor includes a flattened region, and the at least one magnet has a flattened surface complementary to the flattened region of the rotor.

9. The apparatus as claimed in claim 8, wherein the first pole cap is mounted to the rotor by a bar that engages an axially extending indentation of the first pole cap and that also engages an axially extending indentation of the second pole cap to laterally align the first and second pole caps.

10. The apparatus as claimed in claim 9, further comprising a bracket secured to the rotor adjacent to the flattened region formed at the rim of the rotor and including a mounting structure; and the bar engages with the mounting stricture to mutually align the first and second pole caps with each other and with the at least one magnet for locating the displaced magnetic field of the magnet relative to the rotor.

11. An electrical machine, comprising:
a rotor rotatably mounted within the electrical machine:
a plurality of magnets disposed on the rotor, each magnet producing a magnetic field;
a first plurality of pole caps proximate to the plurality of magnets disposed on the rotor, and magnetically coupling with a first group of the plurality of magnets to produce a first plurality of pole cap magnetic fields displaced from the magnetic fields of the magnets; and
a second plurality of pole caps proximate to the plurality of magnets disposed on the rotor, and magnetically coupling with a second group of the plurality of magnets to produce a second plurality of pole cap magnetic fields displaced from the magnetic fields of the magnets:
the displacement of the first and second pluralities of pole cap magnetic fields from the first and second plurality of magnet magnetic fields reduces torque ripple induced by rotation of the rotor within the electrical machine.

12. The electrical machine as claimed in claim 11, wherein the first plurality of pole cap magnetic fields and the second plurality of pole cap magnetic fields form an axial stair step pattern.

13. The electrical machine as claimed in claim 11, wherein the first plurality of pole cap magnetic fields and the second plurality of pole cap magnetic fields form substantially continuous helices.

14. The electrical machine as claimed in claim 11, wherein the first plurality of pole cap magnetic fields and the second plurality of pole cap magnetic fields are mirror-symmetrically axially skewed.

15. The electrical machine as claimed in claim 11, wherein the electrical machine is a generator.

16. A method comprising:
establishing circumferential locations within an electrical machine of first and second pluralities of pole pieces producing pole piece magnetic fields; and
displacing the first plurality of pole piece magnetic fields by a first offset.

17. The method as claimed in claim 16, wherein displacing the first plurality of pole piece magnetic fields includes disposing proximate to selected pole pieces a first plurality of pole caps having a first asymmetric magnetic profile.

18. The method as claimed in claim 16, further comprising:
displacing the second plurality of pole piece magnetic fields by a second offset different from the first offset.

19. The method as claimed in claim 18, wherein the first and second pluralities of displaced magnetic fields form an axial stair step pattern.

20. The method as claimed in claim 18, wherein the first and second pluralities of displaced magnetic fields are axially continuous and skewed from the rotor axis.

21. The method as claimed in claim 18, wherein the first and second pluralities of displaced magnetic fields are symmetrically axially skewed.

22. An apparatus comprising:
a rotor:
a magnet disposed on the rotor, and producing a magnetic field; and
a pole cap proximate to at least one magnet disposed on the rotor, wherein the pole cap is magnetically coupled to the magnet and has a laterally asymmetric profile.
